(19) United States
(12) Patent Application Publication
(10) Pub. No.: US 2019/0116778 A1
(43) Pub. Date: Apr. 25, 2019

(54) Pearl-Away

(71) Applicant: Thomas Joseph Lavin, Wilmington, NC (US)

(72) Inventor: Thomas Joseph Lavin, Wilmington, NC (US)

(21) Appl. No.: 15/790,487

(22) Filed: Oct. 23, 2017

(51) Int. Cl. A01M 21/04

(52) U.S. Cl. CPC A01M 21/046

(57) ABSTRACT

A convenient effective means is provided to eliminate the lawn pest known as “ground pearl” (Margarodes spp), a subterranean member of the scale family, that is immune to chemical lawn treatment applications.

This, electrically equipped, hand propelled, device is simply pushed back forth over and around on the turf areas where pearl damage is evident. The design's 4 caster wheels provide an independently sprung suspension permitting close ground clearance during operation insuring full personal safety when used properly.

The design utilizes a magnetron to provide high frequency electromagnet wave energy that is fully confined and directed only strait down into the earth via a one wave length long strait wave guide that maximizes the E field at ground level. From there the wave radiates into the earth hemi spherically with the familiar strength loss as the square of the distance. Fortunately, pearl live close to the surface where they are vulnerable.

The microwave frequency band used is not high enough to be an ionization radiation threat to people or pets. It can however lethally damage the subject organism by agitating the pearl's internal water molecules despite its protective covering.

### BACKGROUND OF THE INVENTION

This presented invention pertains to the control of a severely destructive lawn pest commonly referred to as “ground pearl.” It is a form of garden scale that has proven to be extremely costly and virtually impossible to eliminate from cultivated lawns. Golf courses, cemeteries, parks, industrial sites, estates and ordinary homes, having cultivated turf, are being devastated by this pest. I understand that sugar farms in Australia have to fight pearl to protect their crop production.

Lawn care companies appear helpless in effectively dealing with pearl because the bug seems to be impervious to all presently available lawn treatment chemicals. The difficulty with the chemical approach is that the pearl bug seems to have a wax type of coating that prevents epidermis absorption. They apparently only take on nutrients through their piercing sucking mouth parts they insert into the grass and suck out what they need to survive from the root system of the grass. They eventually kill the grass leaving large areas of damage.

People have tried to get rid of their pearl infestations by scraping all of the sod off their entire lawn and then removing the top 6″ to 8″ of top soil, an extremely costly solution, only to have pearl reappear in two or three years.

My invention uses a non-chemical approach that is capable of causing severe damage to the bug such that it will no longer be able to sustain itself or will be killed in situ.

### SUMMARY OF THE INVENTION

The unique and novel concept proposed by this invention submission is to avoid the chemical approach and use electromagnetic energy waves of sufficient power and frequency to interfere with the pearl life cycle. A device capable of safely injecting said energy directly into the soil is herein described.

The necessary individual components and sub-assemblies capable of generating such waves of electromagnetic energy are fortunately already in mass production for an entirely unforeseen and different purpose. This means that a suitable configuration can be designed and assembled using selected mass produced components and sub-assemblies to provide a reasonable cost for the proposed invention. The components would principally be available from the microwave oven industry. For example a high powered microwave oven using a magnetron to supply the electron stream that can produce over 1200 watts of rf power on the order of 2.45 ghz.

### BRIEF DESCRIPTION OF THE DRAWINGS

FIGS. 1 and 2 along with block diagram FIG. 3 Illustrate the simplest configuration of the proposed equipment. It is familiar looking upon a casual glance and could be confused with an ordinary walk behind mower. It is significantly different in the following regards: It is very close to the ground by virtue of the 4 caster assemblies that provide independent 4 wheel suspension as illustrated in FIG. 4. It is easily portable and usable by a single properly trained operator. The trained operator manually slides the unit back and forth and around over the closely mowed and/or damaged grass holding the output level and enabling the output wave guide to inject electromagnetic energy directly into the ground where pearl has been detected.

In order to insure safety aspects to people and pets switches are provided that stop operation of the magnetron. Whenever the unit is not, on the ground properly oriented, the operator has not turned on the system key and he is not in the walk behind position pulling the squeeze handle it will not turn on.

### DETAILED DESCRIPTION OF THE PREFERRED EMBODIMENT

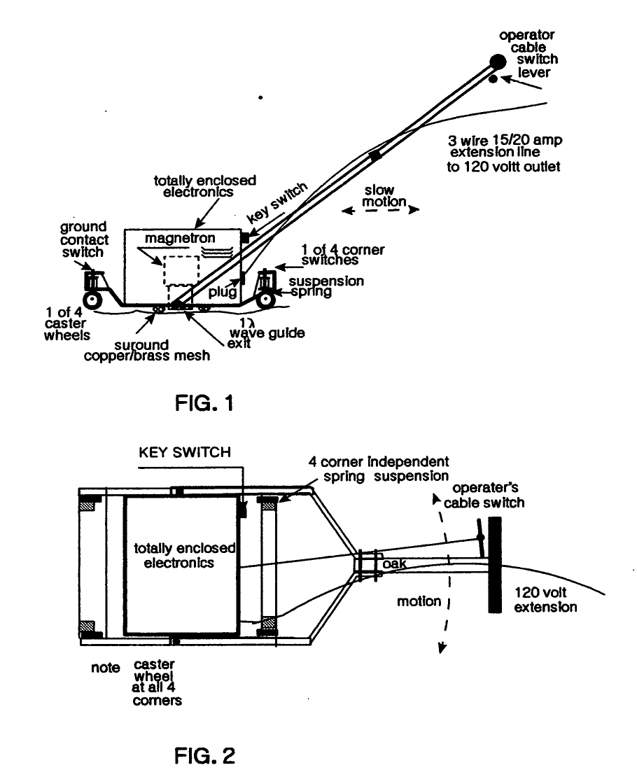

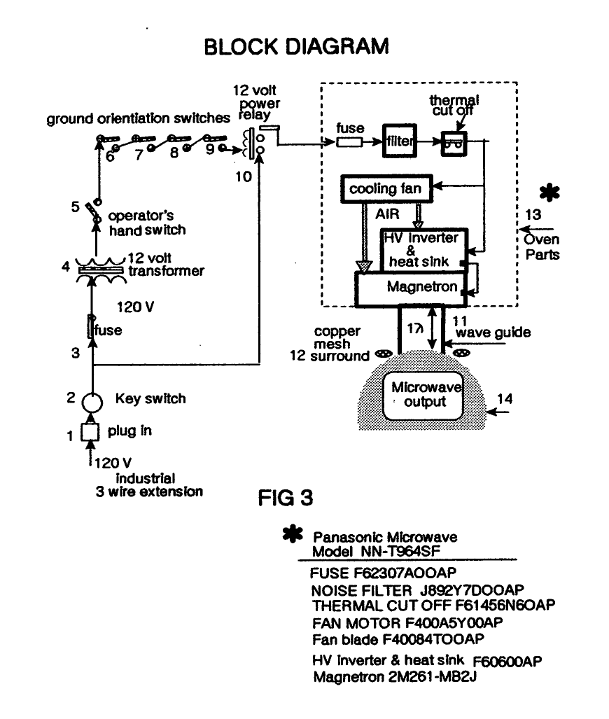

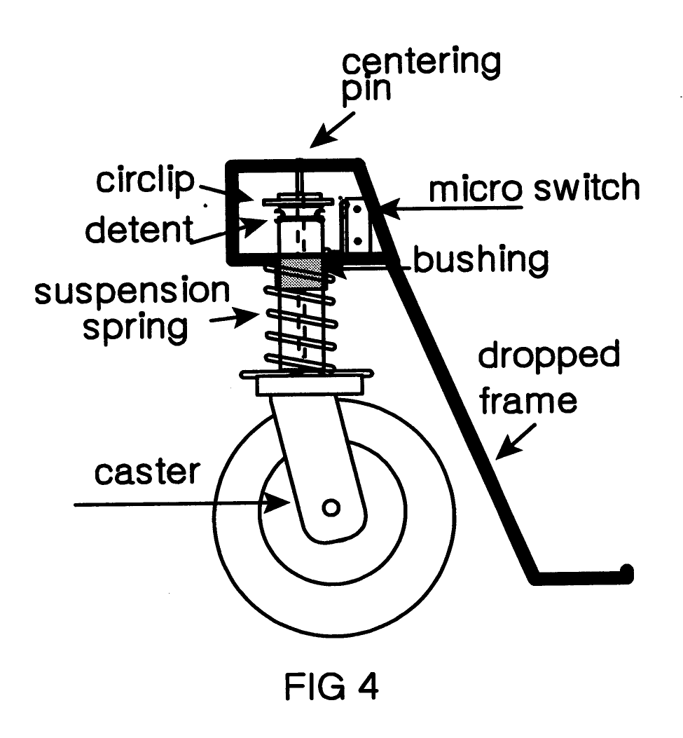

The block diagram shown in FIG. 3 is the best and quickest way to understand the functionality of the invention depicted in FIG. 1 and FIG. 2. They display the configuration first conceived that would provide the simplest system arrangement compatible with mobilizing the necessary microwave equipment that can be operated simply by one man, say a qualified, trained, professional lawn care person.

FIG. 3 is divided into 2 functionally separate hardware groups; the left side consists of the components related to safety. The right side 13, within the dotted outline, clearly shows the configuration of microwave subassemblies that are related to producing the electron stream that is captured by the wave guide in order to organize confine it and direct the wave stream into the ground. An available duplicate of each oven device shown within 13 can be purchased using the supplied part numbers under the asterisk.

The wave guide 11 is attached to the external moving frame using thermal insulation to minimize conduction and heat loss. Its cross section matches the magnetron's output; it is made of shiny copper on the inside and is one wavelength, 4.82 inches, long.

To confine any leakage to beneath the system there is a crushable ring of copper or brass mesh that is configured by rolling a length of 4 inch wide screen along itself, while advancing its overlap, so to achieve adequate length and multiple layers. It is attached under the housing using a narrow 3/16″ thick mounting support ring on the screen's inside top surface.

The left side of FIG. 3 shows among other things a string of switch components that control and supply excitation to the “oven” section. For safety reasons these components, being outside the Faraday cage, are operated at 12 volts.

The 3 wire plug 1 is mounted to the frame and accepts heavy duty extensions from house power or a portable generator. It along with the key switch 2, the panel mounted fuse 3, the 12 v transformers 4, the operator's hand switch 5 and the power relay 10 are all under the machine's cover away from the easy reach of people.

The operator's mechanical switch 5 is operated by pull cable that is connected to a squeeze handle on the operator's handle bar.

The offset raised design of the mounting position of the caster wheels provides for a coil spring and a micro-switch 6,7,8,9 arrangement at each of the corners. They are supported by a hardened pin that fits down the center of the usual caster mounting pin. The raised wheel mounting off set permits the lower center section of the design to hold through an alignment mounting block, and up onto its hardened pin. Each caster assembly is held in place by a circlip. The micro-switches have an actuation lever with a formed roller on its end. The end falls into a decent machined in the caster's mounting tube. When the spring is fully extended the machine is not resting on the ground and switches 6, 7, 8, and 9 will be open. This arrangement allows sufficient suspension motion in use without causing numerous interrupts to the microwave system while in operation.

It should be understood that many other multi-magnetron configurations can be Imagined and used. These large multi-magnetron systems and their associated wave guides suitable for fixed repeated placement or slow towing behind a tractor are easily configured using portable generator sets or battery and inverter arrangements. Multiple-magnetron arrangements and associated wave guides are among the subject claims.

Consider the arrangement of several independent magnetron units with their wave guides mounted in a large single housing together with all their electronics and power supplies arranged such that the edges of their wave guide output radiation patterns overlapped. Such a device could be set at a fixed place for a period of time by a garden tractor. The process could then be repeated according to a pearl cure plan until the entire area was treated. The plan would be crafted in accordance with the geometrical pattern the multiple magnetron unit as designed, be it a linear array a rectangular arrangement or a triangular one.

What is claimed is:

1. A ground pearl treating device composed of: an on the ground machine having the means and ability to produce high frequency electromagnetic wave energy to disrupt the lifecycle and kill the subject ground pearl;
An energy efficient, one wave length, transmitting wave guide that direct the electron field straight down into the ground;
A safely operable machine with a metal cover that totally encloses the high voltage sections except for the wave guide opening and louvered cooling provisions;
A spring mounted, captured caster wheel assembly at each corner of the machine independently suspending it such that the wave guide is close to the ground, in the desired vertical output position. Such casters allowing rolling motion in all directions to cover pearl patterns as needed;
A micro-switch associated with each caster wheel that is normally open when the machine is not in operating position on the ground but closes when the suspension compresses by weight of the machine.
A cable operated switch routed through the cover up the handle to the squeeze handle on operator's handle bar;
A 120 to 12 volt transformer for low voltage excitation of the external string of sensing switches on the suspension mechanisms;
A low powered panel mounted fuse to protect the sensing circuit components from a short caused by debris on the lawn during operation;
A turnkey operated power on/off switch to deprive unqualified, unauthorized people from operating the machine;
A 12 volt coil operated 120 volt 20 amp rated power relay that excites the magnetron section of the electronics when the sensing circuit permits;
A 3 conductor, heavy duty plug, cover mounted, that accepts an industrially rated extension to deliver 120 volt power to the unit.
A means of maneuvering the machine by a set of handle bars, including a hard wood shaft with a manual grip that accommodates the operator's squeeze handle;
A rolled mesh screen at least 2 layers thick of brass or copper surrounding the underside of claim 1 that easily compresses when the machine is in operating position. The screen blocks any substantial wave leakage out of the sides.

2. A machine as described in claim 1, wherein magnetron energy is directed into the ground for the purpose of disrupting ground pearl:
Any multiple configurations of magnetrons and wave guides with their supporting electronics providing overlapping microwave pattern edges with the aim of disturbing or killing the subject ground pearl over large areas.

3. A machine as described in claim 1, wherein microwave energy is provided including:
A special slow blow fuse for protection of the entire magnetron section;
An in line filter to minimize line noise caused by the circuitry;
A thermal cut off switch to detect an overheating condition and protect the components;
A cooling fan to produce forced air over the hot running components;
A hi voltage inverter with heat sinks to supply operating voltages to the magnetron;
A magnetron capable of producing a radio frequency with sufficient energy for the intended purpose at 2.46 Ghz.
